(19) United States
(12) Patent Application Publication
(10) Pub. No.: US 2011/0029877 A1
(43) Pub. Date: Feb. 3, 2011

(54) Method of Creating a Presentation in Real Time

(75) Inventors: Saurabh Kumar Panjwani, Redmond, WA (US); Kentaro Toyama, Redmond, WA (US); Karl Fenech, Luqa (MT); Luana Micallef, Gzira (MT); Natalie Linnell, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/533,071

(22) Filed: Jul. 31, 2009

(51) Int. Cl. G06F 3/01

(52) U.S. Cl. 715/731

(57) ABSTRACT

An electronic display page may be displayed on an electronic display and electronic input elements may be displayed on the electronic display. If there are additional input elements, the additional electronic input elements may be accepted from an electronic input device for the electronic presentation and the additional electronic input elements may be added to the existing electronic input elements. The new electronic display page may be added to the electronic display page to create a sequence of electronic display pages, and the sequence of electronic display pages may be displayed.

### BACKGROUND

This Background is intended to provide the basic context of this patent application and it is not intended to describe a specific problem to be solved.

Creating electronic presentations takes time, planning and care. Often times, significant time is expended on adding a variety of electronic elements to a presentation and making the elements appear consistent and professional. Again, this takes time. Oftentimes during a presentation, a question may arise which could be easily answered with an illustration but creating an illustration on the fly has been a challenge.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A method of creating a presentation is disclosed. An electronic display page may be displayed on an electronic display and electronic input elements may be stored. The method may determine if there are additional electronic input elements. If there are additional input elements, the additional electronic input elements may be accepted from an electronic input device for the electronic presentation, the additional electronic input elements may be added to the existing electronic input elements. Modifications to the electronic input elements may be accepted to create display input elements. The display input elements may be allowed to be added to the electronic display page or to an additional electronic display page to create a new electronic display page. The new electronic display page may be added to the electronic display page to create a sequence of electronic display pages; and the sequence of electronic display pages may be displayed.

### BRIEF DESCRIPTION OF THE DRAWINGS

FIG. 1 is an illustration of a computing device;

FIG. 2 is an illustration of a method of creating an electronic presentation;

FIG. 3 is an illustration of an electronic illustration;

FIG. 4 is an illustration of an electronic illustration and a separate window for electronic elements to be added to the electronic illustration; and

FIG. 5 is an illustration of an electronic illustration of an electronic illustration and a controller illustration with a graduated interface.

### SPECIFICATION

Although the following text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

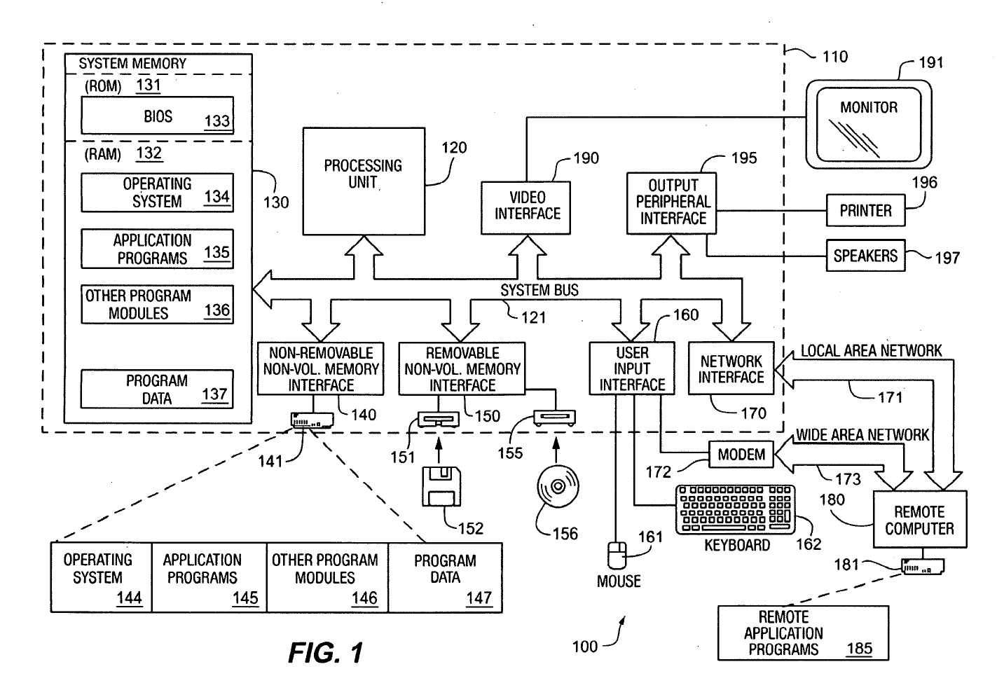

FIG. 1 illustrates an example of a suitable computing system environment 100 that may operate to execute the many embodiments of a method and system described by this specification. It should be noted that the computing system environment 100 is only one example of a suitable computing environment and is not intended to suggest any limitation as to the scope of use or functionality of the method and apparatus of the claims. Neither should the computing environment 100 be interpreted as having any dependency or requirement relating to any one component or combination of components illustrated in the exemplary operating environment 100.

With reference to FIG. 1, an exemplary system for implementing the blocks of the claimed method and apparatus includes a general purpose computing device in the form of a computer 110. Components of computer 110 may include, but are not limited to, a processing unit 120, a system memory 130, and a system bus 121 that couples various system components including the system memory to the processing unit 120.

The computer 110 may operate in a networked environment using logical connections to one or more remote computers, such as a remote computer 180, via a local area network (LAN) 171 and/or a wide area network (WAN) 173 via a modem 172 or other network interface 170.

Computer 110 typically includes a variety of computer readable media that may be any available media that may be accessed by computer 110 and includes both volatile and nonvolatile media, removable and non-removable media. The system memory 130 includes computer storage media in the form of volatile and/or nonvolatile memory such as read only memory (ROM) 131 and random access memory (RAM) 132. The ROM may include a basic input/output system 133 (BIOS). RAM 132 typically contains data and/or program modules that include operating system 134, application programs 135, other program modules 136, and program data 137. The computer 110 may also include other removable/non-removable, volatile/nonvolatile computer storage media such as a hard disk drive 141 a magnetic disk drive 151 that reads from or writes to a magnetic disk 152, and an optical disk drive 155 that reads from or writes to an optical disk 156. The hard disk drive 141, 151, and 155 may interface with system bus 121 via interfaces 140, 150.

A user may enter commands and information into the computer 110 through input devices such as a keyboard 162 and pointing device 161, commonly referred to as a mouse 161, trackball or touch pad. Other input devices (not illustrated) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device may also be connected to the system bus 121 via an interface, such as a video interface 190. In addition to the monitor, computers may also include other peripheral output devices such as speakers 197 and printer 196, which may be connected through an output peripheral interface 195.

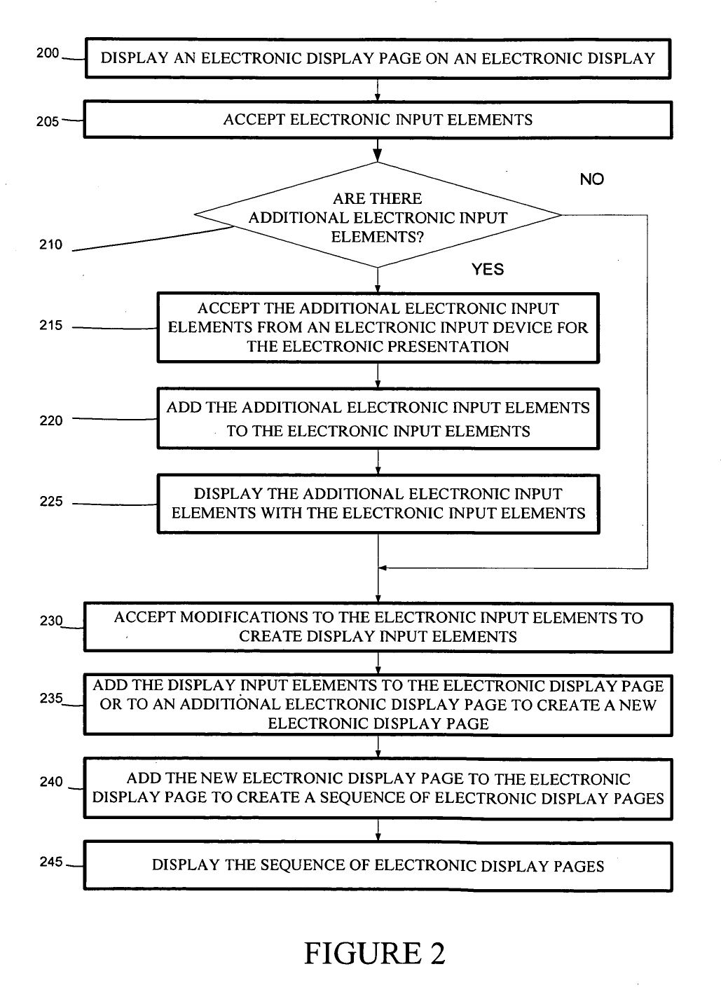

FIG. 2 illustrates one embodiment of a method of creating an electronic presentation. The electronic presentation may be used in a variety of environments but may have some common characteristics. More specifically, the various embodiments of the method may allow the easy creation of presentations, including presentations “on the fly” or in real time. Simply by moving a mouse 161 and making some selections, a presentation may be easily created. For example, a teacher may be able to use the various embodiments of the method to create on the fly presentations to a class with little knowledge, experience or training with computers or presentation applications. Even students may be able to use the embodiments to create presentations with minimal supervision and training. In addition, as time is often limited for teachers, presentations may be completed in less time with less effort but still make look very polished and professional. Further, previously created presentations may be easily modified or tailored to a specific class, class level, to reflect current events.

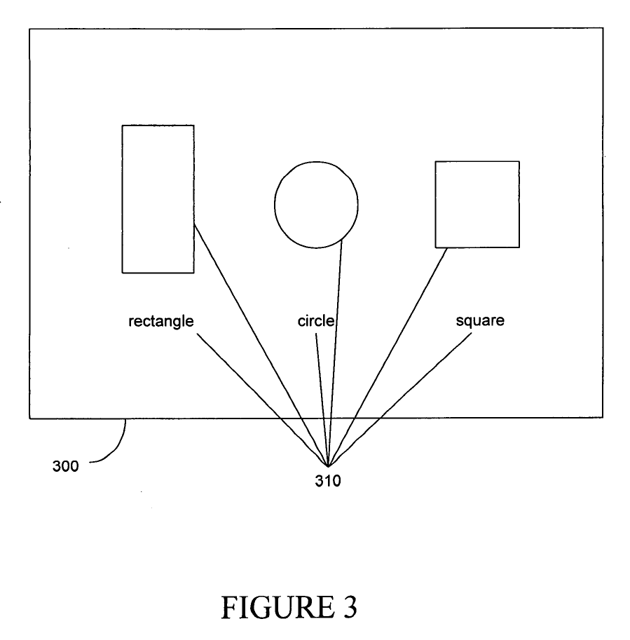

At block 200, an electronic display page may be displayed on an electronic display. The electronic display may be a monitor such as monitor 191 or may be in any form of a display 191 such as a projection. The electronic display page may be an illustration that is displayed. The illustration may have text, images, drawings, animations, movies, sound clips and virtually any electronic file including electronic versions of non electronic input such as scan of newspapers, or electronic recordings of live performances. Like any illustration, the illustration may be made up of electronic input elements. FIG. 3 may be a sample illustration 300 with various electronic elements 310. The electronic input elements 310 may be elements in a digital photo, such as a flower in a photo of a field, the photo itself, text below a photo, sound bites from a sound file, a variety of digital photos that are joined or photos may be over-laid to make a single illustration 300. The illustration 300 may be broken down into electronic elements 310 that make up the illustration 300.

At block 205, electronic input elements 310 may be accepted into the computing system. The electronics input elements 310 may be text, digital photos, electronic scans of documents or photos, sound files, video files or any other electronic file in whole or in part that may be desired to be added to the electronic display. In other embodiments, the electronic input element 310 is user input. The user input may be a drawing, text or anything else that may be created by a user. If the electronic input element 310 is a sound file, the file may be noted by a sound related icon, or by displaying the name of the file, for example. The electronic illustration 300 may be one or more pages of illustrations 300 and the electronic input elements 310 may be modified by selecting a section from the electronic input element 310. In some embodiments, an optical character recognition program may be applied to the electronic input element 310.

At block 210, it may be determined if there are additional electronic input elements. The determination may be whether electronic input elements 310 have been sensed, if electronic input elements 310 are waiting to be added to the electronic illustration 300 or if a user has indicated that additional electronic elements 310 are waiting. If an input device 320 is activated, the electronic input element 310 may be automatically obtained from an attached input device 320 and the electronic input element 310 may be added to the electronic display page 300 or to a memory where it can be added to the electronic display 300 at another time. If the determination is negative, the method may skip to block 230. It should be noted that in some embodiments, the method may check continuously for additional electronic input elements 330.

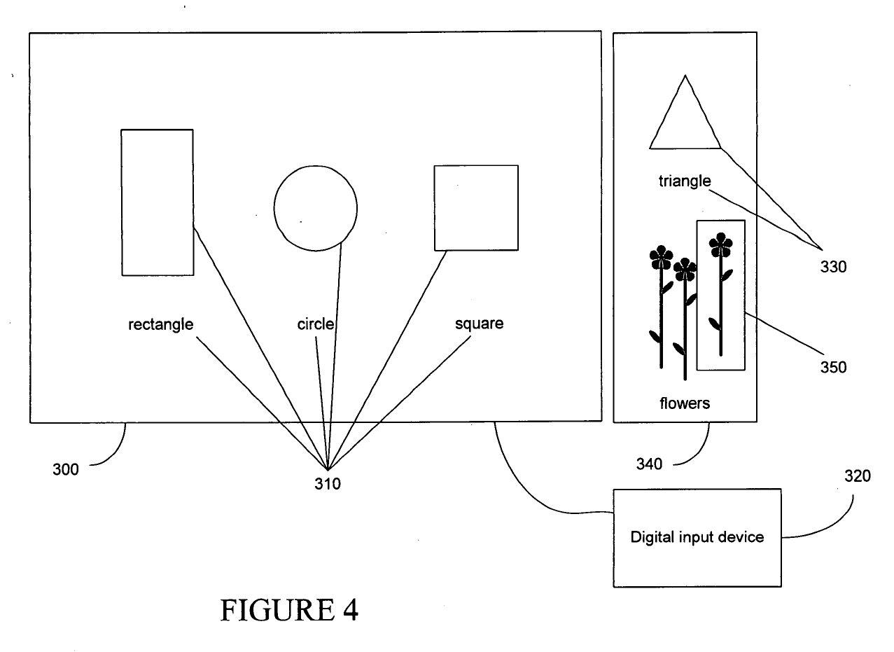

If the determination at block 210 is affirmative, at block 215, additional electronic input elements 330 may be received from the electronic input device 320 for the electronic presentation 300. FIG. 4 may illustrate the electronic input device 320 being in communication with a computing device executing one of the many embodiments of the method. The electronic input device 320 may be any device capable of delivering digital images or text to the application. As some examples and not limitations, the electronic input device 320 may be a scanner, a digital camera, an electronic whiteboard, an interactive white board, a tablet/stylus type input device and a portable storage device. The additional elements may be displayed in many useful ways. In one embodiment, a separate window 340 displays the additional electronic input elements 330.

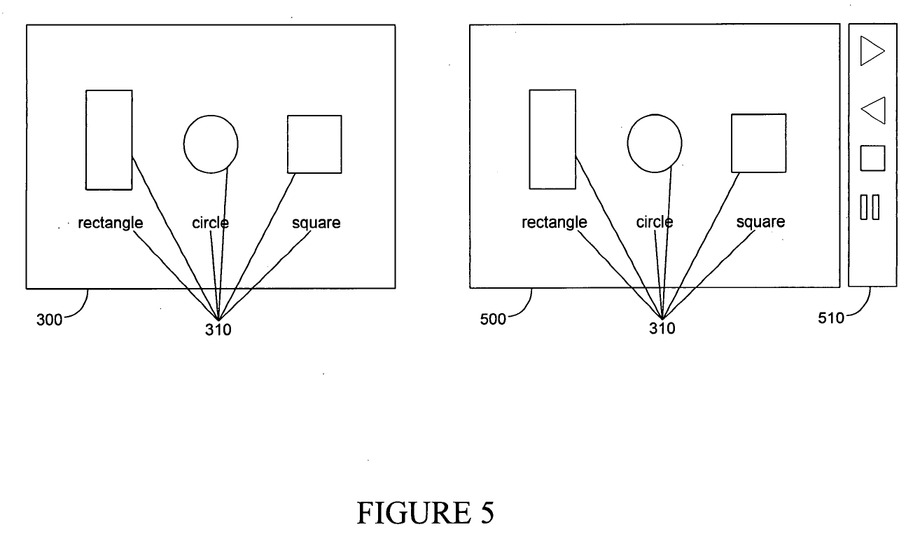

In another embodiment, the additional elements 330 may be displayed in a second illustration that is only visible to an organizing agent. FIG. 5 may be an illustration of one such arrangement. The electronic illustration 300 may be viewable by everyone whereas the control illustration 500 may only be visible by the organizer. The control illustration 500 may have additional options 510 to control the illustration 300, add additional electronic elements 310 to the illustration 300, create entire new illustrations, etc. By having the illustration 300 and the control illustration 500, new illustrations 300 and modifications to the illustrations 300 may be made while an illustration is occurring. The electronic illustration 300 and the control illustration 500 may be on separate displays 191 or may be on the same display 191.

The control illustration 500 may have a graduated user interface 510. The graduated user interface 510 may make it easier for users, including novice users, to use the various embodiments of the application. If the user is a novice, fewer features may be displayed or used and as the user gains experience, additional features may be desired. The additional features may then be added to the graduated interface. Similarly, an experienced user may select to have many features displayed right away and then only the features that are used often may be displayed. In this way, novice users will not be overwhelmed and additional features and tools may be added over time. Similarly, experienced users may select to display the tools they anticipate using most often and may avoid being presented tools that are not useful to them or to the task at hand. In one embodiment, the user interface may have a minimum of inputs such as “forward,” “back,” “stop,” “play” and “more.” In other embodiments, the method may observe which “more” functions are used and these may be added to the graduate interface. In yet another embodiment, the user may select to which functions should be added to the graduated interface. An additional advantage of the graduated interface is that it is easier to add in content “on the fly” when there are fewer options available to select in the interface.

At block 220, the additional electronic input elements 330 may be added to the existing electronic input elements 310 and at block 225, the additional electronic input elements 330 may be displayed with the existing electronic input elements 310. The additional elements 330 may be added in a variety of ways. In one embodiment, the entire electronic input element is dragged from the additional window 340 onto the electronic illustration 300. The display of the additional element 330 may be automatic or may be confirmed. In yet another embodiment such as in FIG. 5, the additional elements 330 may be displayed only on the control illustration 500. The changes may be made to the control illustration 500 and then the changes may be made to the electronic illustration 300.

At a lower level, the additional elements 330 may contain many elements and only part of additional elements 330 may be desired to be added to the electronic illustration 300. In these cases, a square, circle or other cropping device may be available to easily select the desired section of the additional elements 330 which may then be added to the electronic illustration 300 or to an additional electronic illustration.

At block 230, modifications to the electronic input elements 330 may be accepted to create display input elements 350. Display input elements 350 are the electronic elements 330 that are actually displayed. In FIG. 4, the additional electronic image 330 may be of a plurality of flowers and only one flower is desired. A single flower may be selected as the display input element 350 and it may then be added to the electronic display 300. The addition may be by dragging and dropping the input element 350, using a mouse 161, by moving on a tablet input interface, by a keystroke or through a drop-down menu. Of course, other methods are possible and are contemplated.

A zoom function may be used to adjust the size of display input elements 350 to a desired size or to fill a predefined space. The zoom function may also take steps to improve the clarity and view-ablility of the display input elements 350 being increased in size. Similarly, a shrink function may be used to reduce the display input elements 350 to a predetermined size. As a result, the display input elements 350 may automatically be made to fit into a desired space without difficult re-sizing.

Other modifications are also possible. For example, the modification may entail selecting a portion of the electronic input element 330, resizing the electronic input element 330 to fit a desired size, rotating the electronic input element 330 to be rotationally appropriate for proper viewing and improving the contrast of the electronic input element 330 to become the display input element 350. Of course, other modifications are possible and are contemplated. In some embodiments, the modifications are automatic. For example, the electronic input element 330 may be expanded or reduced to fit a known space or be displayed at a desired resolution. Further, the method may automatically take elements 330 place on an electronic page 300 and arrange them in a manner consistent with other electronic pages 300.

At block 235, the display input elements 350 may be permitted to be added to the electronic display page 300 or to an additional electronic display page to create a new electronic display page. The display input elements 350 may be arranged in virtually any fashion. In one embodiment, the display input elements 350 may be separate, and in another embodiment, the display input elements 350 may be overlaid. In more advanced embodiments, additional features may be added to the display input elements 350.

The elements 350 also may be added as a function of time or by a user pressing a key or otherwise making an input. In some embodiments, a rectangle is used to occlude parts of electronic display pages 300. The rectangle (or any appropriate shape) may be moved to gradually display more and more of the electronic display page 300. For example, if the electronic display page 300 is a math problem, the steps in solving the problem may be displayed one line at a time by simply moving the rectangle down the page, line by line.

At block 240, the electronic display page may be added to the electronic display page to create a sequence of electronic display pages. It may be added to the sequence at the spot currently being displayed, at the end or at any place desired. At block 245, the new sequence of electronic display pages may be displayed.

As a result, an electronic display page 300 may be shown on an electronic display and could begin in a classroom for example. Students might draw illustrations and these illustrations may be scanned in through the electronic input device 320. The illustrations may be immediately added to the electronic display page 300 or may be held on a page only viewable by a control person. The illustration in whole or in part may be added to an electronic display image 300 and may be displayed in real time. Additional electronic illustrations may be added to existing pages or new pages, again, in real time. A zoom function may be used to further analyze electronic input elements 310. A simplified and graduated interface may be used to make the entire process easier for a non-technical user.

In conclusion, the detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

1. A method of creating an electronic presentation in real time comprising:
displaying an electronic display page on an electronic display;
displaying at least one electronic input element on the electronic display;
if there are additional electronic input elements:
accepting the additional electronic input elements from an electronic input device for the electronic presentation;
adding the additional electronic input elements to the electronic input elements; and
displaying the additional electronic input elements with the electronic input elements;
accepting modifications to the electronic input elements to create display input elements;
adding the display input elements to the electronic display page or to an additional electronic display page to create a new electronic display page;
adding the new electronic display page to the electronic display page to create a sequence of electronic display pages; and
displaying the sequence of electronic display pages.

2. The method of claim 1, wherein displaying the electronic input elements of the electronic display further comprises:
displaying the electronic input elements in a first portion of the electronic display;
displaying the electronic display page in a second portion of the electronic display;
allowing the electronic input elements to be moved from the first portion to the second portion; and
adding the electronic input elements to the electronic display page.

3. The method of claim 1, wherein accepting modifications to the electronic input elements further comprises at least one selected from a group comprising:
selecting a portion of the electronic input element;
resizing the electronic input element to fit a desired size;
rotating the electronic input element to be rotationally appropriate for proper viewing; and
improving contrast of the electronic input element.

4. The method of claim 1, further comprising converting the electronic input elements to be a predetermined size and clarity before displaying the electronic input elements as display input elements.

5. The method of claim 1, wherein the electronic input element comprises a page of text and the electronic input element is modified by selecting at least one selected from a group comprising a word, a sentence and a paragraph from the electronic display page.

6. The method of claim 5, further comprising applying an optical character recognition program to the electronic input element.

7. The method of claim 1, further comprising overlaying the electronic input elements.

8. The method of claim 1, wherein the electronic input element is user input.

9. The method of claim 1, further comprising displaying a graduated user interface.

10. The method of claim 9, wherein the electronic input elements displayed in the graduated user interface are user selected.

11. The method of claim 1, further comprising if an image device is activated, automatically obtaining the electronic input element from an attached device and adding the electronic input element to the electronic display page.

12. The method of claim 1, wherein the electronic image device comprises at least one selected from a group comprising a scanner, a digital camera, an electronic whiteboard, and a portable storage device.

13. The method of claim 1, further comprising displaying a first electronic display page for an administrator and a second electronic display page for viewers wherein the second electronic display page and the first electronic display page comprise common elements.

14. A computer storage medium comprising computer executable instructions for creating an electronic presentation in real time, the computer executable instructions comprising instructions for:
displaying an electronic display page on an electronic display;
displaying at least one electronic input element on the electronic display;
if there are additional electronic input elements:
accepting the additional electronic input elements from an electronic image device for the electronic presentation;
adding the additional electronic input elements to the electronic input elements; and
displaying the additional electronic input elements with the electronic input elements further comprising
displaying the electronic input elements in a first portion of the electronic display;
displaying the electronic display page in a second portion of the electronic display;
allowing the electronic input elements to be moved from the first portion to the second portion; and
adding the electronic input element to the electronic display page.
accepting modifications to the electronic input elements to create display input elements;
adding the display input elements to the electronic display page or to an additional electronic display page to create a new electronic display page;
adding the new electronic display page to the electronic display page to create a sequence of electronic display pages; and
displaying the sequence of electronic display pages.

15. The computer storage medium of claim 14, wherein accepting modifications to the electronic input elements further comprises computer executable code for at least one selected from a group comprising:
selecting a portion of the electronic input element;
resizing the electronic input element to fit a desired size;
rotating the electronic input element to be rotationally appropriate for proper viewing; and
improving contrast of the electronic input element;

16. The computer storage medium of claim 14, further comprising computer executable code for determining if an image device is activated, automatically obtaining the electronic input element from an attached device and adding the electronic input element to the electronic display page.

17. The computer storage medium of claim 14, wherein the electronic input device comprises at least one selected from a group comprising a scanner, a digital camera, an electronic whiteboard, and a portable storage device.

18. The computer storage medium of claim 14, further comprising computer executable code for displaying a first electronic display page for an administrator and a second electronic display page for viewers wherein the second electronic display page and the first electronic display page comprise common elements.

19. A computer system comprising a processor physically configured according to computer executable instructions for creating an electronic presentation in real time, a memory for storing data to assist the processor and an input/output device, the computer executable instructions comprising instructions for:
displaying an electronic display page on an electronic display;
displaying at least one electronic input element on the electronic display;
if there are additional electronic input elements:
accepting the additional electronic input elements from an electronic input device for the electronic presentation;
adding the additional electronic input elements to the electronic input elements; and
displaying the additional electronic input elements with the electronic input elements further comprising
displaying the electronic input elements in a first portion of the electronic display;
displaying the electronic display page in a second portion of the electronic display;
allowing the electronic input elements to be moved from the first portion to the second portion; and
adding the electronic input element to the electronic display page.
accepting modifications to the electronic input elements to create display input elements wherein accepting modifications to the electronic input elements further comprises computer executable code for at least one selected from a group comprising:
selecting a portion of the electronic input element;
resizing the electronic input element to fit a desired size;
rotating the electronic input element to be rotationally appropriate for proper viewing; and
improving contrast of the electronic input element;
adding the display input elements to the electronic display page or to an additional electronic display page to create a new electronic display page;
adding the new electronic display page to the electronic display page to create a sequence of electronic display pages; and
displaying the sequence of electronic display pages.

20. The computer system of claim 19, further comprising computer executable code for determining if an input device is activated,
automatically obtaining the electronic input element from an attached device and adding the electronic input element to the electronic display page and
further comprising computer executable code for displaying a first electronic display page for an administrator and a second electronic display page for viewers wherein the second electronic display page and the first electronic display page comprise common elements.
